(19) United States
(12) Patent Application Publication
(10) Pub. No.: US 2003/0224313 A1
(43) Pub. Date: Dec. 4, 2003

(54) Dental appliances having attachable upper and lower halves and systems and methods for treating malocclusions

(76) Inventor: Earl O. Bergersen, Dorado, PR (US)

Correspondence Address: PATENTS+TMS, A Professional Corporation, 1914 North Milwaukee Avenue, Chicago, IL, 60647, US

(21) Appl. No.: 10/449,292

(22) Filed: May 30, 2003

Related U.S. Application Data
(60) Provisional application No. 60/384,744, filed on May 30, 2002.

(51) Int. Cl. A61C 3/00

(52) U.S. Cl. 433/6

(57) ABSTRACT

Dental appliances and systems and methods for treating malocclusions are provided. The dental appliances may have an upper shell and a lower shell which receive upper teeth and lower teeth, respectively, of a user. In addition, the upper shell and the lower shell may be attached by a fastening device, such as, for example, snaps, magnets, or the like. By attaching the upper shell and the lower shell, the dental appliance may treat malocclusions, such as, for example, overjet or overbite. The upper shell and/or the lower shell may be constructed from a hard material and a softer material, respectively. In an embodiment, the upper shell and the lower shell may be connected by, for example, a spring or a hinge.

This application claims the benefit of U.S. Provisional Application Serial No.: 60/384,744, filed May 30, 2002.

### BACKGROUND OF THE INVENTION

The present invention relates to dental appliances having removable attachable upper and lower halves and systems and methods for treating malocclusions. More specifically, the present invention relates to dental appliances which may have computer-generated upper shells and lower shells which are attached to treat malocclusions such as, for example, overjet or overbite. It is generally known to provide dental care to a patient. Typically, the patient may visit, for example, a dentist or other type of care provider at the office of the care provider. The dentist, for example, may then examine the patient using various techniques, including x-raying the area to be treated or other image-taking technique. The dentist may then provide the patient with a dental appliance to treat the condition of the patient. For example, a patient may have an overbite which may require a dental appliance to be placed within the mouth of the patient for an amount of time. The dentist treating the patient may take images of an interior of the mouth of the patient.

The images may be used to determine a size or a shape of an upper shell and a lower shell which may receive upper and lower teeth, respectively, of the patient. The upper shell and the lower shell may be worn within the mouth of the user to treat the dental condition. However, the upper shell and the lower shell may not be connected. As a result, the upper shell and lower shell are devoid of an interconnection that is essential for antero-posterior and overjet corrections.

A need, therefore, exists for dental appliances and systems and methods of treating malocclusions wherein an upper shell and a lower shell may be attached to treat malocclusions.

### SUMMARY OF THE INVENTION

According to a first aspect of the invention, a dental appliance is provided comprising an upper shell designed to receive the upper teeth of a user and a lower shell designed to receive the lower teeth of the user wherein the dental appliance comprises connecting means for removably attaching the upper shell to the lower shell.

The connecting means may comprise interlockable snaps, interlockable wedges, a hinge, magnets, loop fasteners or a mixture of these.

Where the connecting means comprise wedges, these may advantageously be integrally formed in the dental appliance. More specifically, the connecting means may comprise an upper buccal wedge attached to the upper shell and a lower buccal wedge attached to the lower shell.

Where the connecting means comprise a hinge, the upper shell may comprise an upper hinge slot and the lower shell may comprise a lower hinge slot such that one end of the hinge is insertable into the upper hinge slot and the other end is insertable into the lower hinge slot. The hinge may advantageously be retained in the upper and lower hinge slots by a friction fit.

Where the connecting means comprise magnets, these are advantageously located within the upper and lower shells, so as to be adjacent in use.

The dental appliance according to the present invention may advantageously comprise lingual tabs, which are preferably attached to the lower shell.

In a further advantageous embodiment, the dental appliance may additionally comprise a labial shield, which is preferably attached to the upper shell.

The dental appliance according to the present invention may be constructed from plastic, rubber, silicone or a mixture of these materials. In particular, the present dental appliance may comprise polyvinyl chloride, acrylic or a mixture of these materials. Particularly advantageously, the dental appliance according to the invention comprises areas of hard material and areas of relatively soft material.

Advantageously, the dental appliance according to the present invention is sized not to extend to the first and/or second permanent molars of the user.

In a further advantageous embodiment, the present dental appliance comprises holes in a front portion of the lower and/or upper shell.

According to a second aspect of the invention, a method of treating dental malocclusions, particularly overjet or overbite, especially in users with deciduous dentition, is provided, the method comprising the step of fitting the user with a dental appliance comprising an upper shell designed to receive the upper teeth of a user and a lower shell designed to receive the lower teeth of the user, wherein the dental appliance comprises connecting means for removably attaching the upper shell to the lower shell.

According to a third aspect of the invention, a method of correcting dental malocclusions, particularly overjet or overbite, especially in users with deciduous dentition, is provided comprising the steps of:

producing a physical or a digital model of the user's mouth;

producing a dental appliance based on the physical or digital model, the dental appliance comprising an upper shell designed to receive the upper teeth of a user and a lower shell designed to receive the lower teeth of a user wherein the dental appliance comprises connecting means for removably attaching the upper shell to the lower shell;

fitting the user with the dental appliance and requiring them to wear it in an appropriate fashion until the malocclusion is corrected.

According to this method, the digital model may be prepared from a laser scan of the user's mouth. In addition, the dental appliance may be produced manually, by vacuum molding, by pressure or heat molding, by stereolithography or by a combination of these techniques.

To this end, in an embodiment of the present invention, a dental appliance is provided which is worn adjacent to teeth in a mouth of a user. The dental appliance has a generally U-shaped upper shell having a first base having a perimeter wherein the first base has a width which is greater than a width of a tooth of a user and further having a wall extending along the perimeter of the upper shell wherein the upper shell has a male portion extending from the first base. The dental appliance also has a generally U-shaped lower shell having a second base having a perimeter wherein the second base has a width which is greater than a width of a tooth of the user and further having a wall extending along the perimeter of the lower shell wherein the lower shell has a female portion sized to receive the male portion wherein the male portion and the female portion interlock to removably secure the lower shell to the upper shell.

In an embodiment, the dental appliance has sockets within the upper shell wherein the sockets are shaped in correlation to individual teeth of the user.

In an embodiment, the dental appliance has a lingual tab extending from the perimeter of the dental appliance.

In an embodiment, the dental appliance has a socket within the first base wherein the socket is sized to receive at least two teeth of the user.

In an embodiment, the dental appliance has holes within the wall.

In an embodiment, the dental appliance has a shield integrally formed along the perimeter of the upper shell.

In another embodiment of the present invention, a dental appliance is provided which is worn adjacent to teeth in a mouth of a user. The dental appliance has a generally U-shaped shell having a base wherein a first area of the shell is constructed from a first material and a second area of the shell is constructed from a second material wherein the first material is softer than the second material.

In an embodiment, the dental appliance has a second shell attached to the generally U-shaped shell wherein the second shell has a generally U-shaped base.

In an embodiment, the dental appliance has sockets within the shell wherein the sockets are shaped to receive the teeth of the user.

In an embodiment, the dental appliance has a lingual tab extending from the base wherein the tab extends toward the mouth of the user.

In an embodiment, the dental appliance has holes within the shell wherein the holes provide flexibility to the shell.

In an embodiment, the first material is adjacent to teeth requiring correction.

In an embodiment, the second material is adjacent to teeth to be maintained.

In another embodiment of the present invention, a dental appliance is provided which is worn adjacent to teeth in a mouth of a user. The dental appliance has a generally U-shaped first shell wherein the first shell has an outside perimeter and an inside perimeter. The dental appliance also has a generally U-shaped second shell wherein the second shell has an outside perimeter and an inside perimeter. In addition, the dental appliance has a first wedge on the outside perimeter of the first shell. The dental appliance also has a second wedge on the outside perimeter of the second shell wherein the second wedge contacts the first wedge to prevent movement between the first shell and the second shell.

In an embodiment, the dental appliance has a socket within the first shell wherein the socket is shaped to receive at least one tooth of the user.

In an embodiment, the dental appliance has a tab integrally formed along the inside perimeter of the first shell.

In an embodiment, the dental appliance has a socket shaped to receive at least two teeth of the user.

In an embodiment, the first shell is constructed from a first material and the second shell is constructed from a second material wherein the first material is softer then the second material.

In an embodiment, the first wedge is integrally formed with the first shell.

In an embodiment, the first wedge is attached to the first shell.

In another embodiment of the present invention, a dental appliance is provided which is worn adjacent to teeth in a mouth of a user. The dental appliance has a generally U-shaped upper shell having a base. The dental appliance also has a generally U-shaped lower shell having a base. Further, the dental appliance has a hinge having a first end and a second end wherein the first end is connected to the upper shell and the second end is connected to the lower shell and wherein the hinge folds at a point between the first end and the second end.

In an embodiment, the dental appliance has a socket within the upper shell having an occlusal surface wherein the socket receives one of the teeth of the user and further wherein the occlusal surface is flat.

In an embodiment, the upper shell is constructed from a plurality of materials wherein one of the plurality of materials is softer than another material of the plurality of materials.

In an embodiment, the dental appliance has a tab integrally formed with the upper shell wherein the tab has an apex.

In an embodiment, the dental appliance has a shield integrally formed with the upper shell wherein the shield contacts one or more of the teeth of the user.

In an embodiment, the dental appliance has a socket within the upper shell wherein the socket is shaped to receive at least two of the teeth of the user.

In another embodiment of the present invention, a dental appliance is provided which is worn adjacent to teeth in a mouth of a user. The dental appliance has a generally U-shaped first base. The dental appliance also has a generally U-shaped second base adjacent to the first base. In addition, the dental appliance has a first magnet within the first base.

In an embodiment, the dental appliance has a second magnet within the second base wherein a magnetic force exists between the first magnet and the second magnet.

In an embodiment, the dental appliance has a socket within the first base wherein the socket is shaped to receive at least two of the teeth of the user.

In an embodiment, the dental appliance has holes within the first base.

In an embodiment, the dental appliance has a shield integrally formed with the first base wherein the shield covers the teeth of the user.

In an embodiment, the first base is constructed from a first material and the second base is constructed from a second material wherein the first material is softer than the second material.

In an embodiment, the dental appliance has a socket within the first base wherein the socket has a shape coinciding with one of the teeth of the user.

In another embodiment of the present invention, a dental appliance is provided which is worn adjacent to teeth in a mouth of a user. The dental appliance has a generally U-shaped first shell having an outside perimeter and an inside perimeter. The dental appliance also has a generally U-shaped second shell having an outside perimeter and an inside perimeter. Further, the dental appliance has a fastening device attached to the first shell and the second shell wherein the fastening device has a male portion attached to the first shell and a female portion attached to the second shell wherein the male portion and the female portion engage to removably attach the first shell to the second shell.

In an embodiment, the dental appliance has a socket within the first shell wherein the socket is sized to receive one of the teeth of the user.

In an embodiment, the first shell is constructed from a first material and a second material wherein the first material is softer than the second material.

In an embodiment, the fastening device is snaps.

In an embodiment, the dental appliance has a shield integrally formed with the first shell wherein the shield contacts at least one tooth of the user.

In an embodiment, the dental appliance has a socket within the first shell wherein the socket has a flat occlusal surface.

In another embodiment of the present invention, a dental appliance is provided which is worn adjacent to teeth in a mouth of a user. The dental appliance has a generally U-shaped first shell having a top surface which receives upper teeth of a user. The dental appliance also has a generally U-shaped second shell having a bottom surface which receives lower teeth of the user. Further, the dental appliance has a fastening device removably attaching the first shell and the second shell wherein a first distance between the top surface and the bottom surface at the first end is greater than a second distance between the top surface and the bottom surface at the second end.

In an embodiment, the dental appliance has a socket within the first shell wherein the socket is sized to receive at least two of the teeth of the user.

In an embodiment, the fastening device is an adhesive.

In an embodiment, the dental appliance has a tab integrally formed with the first shell wherein the tab extends rearward into the mouth.

In an embodiment, the upper shell is constructed from a plurality of materials having different degrees of rigidity.

In an embodiment, the dental appliance has a socket within the first shell wherein the socket is sized to receive one of the teeth of the user.

In another embodiment of the present invention, a dental appliance is provided which is worn adjacent to teeth in a mouth of a user. The dental appliance has a generally U-shaped upper shell. The dental appliance also has a generally U-shaped lower shell adjacent to the upper shell wherein the upper shell and lower shell are sized to contact the anterior teeth of the user and wherein the upper shell and the lower shell do not contact at least one posterior tooth of the user. In addition, the dental appliance has a fastening device removably attaching the upper shell and the lower shell.

In an embodiment, the dental appliance has a female portion formed with the upper shell and a male portion formed with the lower shell.

In an embodiment, the upper shell is softer in an area which contacts teeth requiring correction.

In an embodiment, the dental appliance has a hinge connected to the upper shell and the lower shell.

In an embodiment, the dental appliance has a shield integrally formed with the upper shell wherein the shield covers the teeth.

In an embodiment, the fastening device is snaps.

In an embodiment, the dental appliance has a socket within the upper shell wherein the socket has a flat occlusal surface.

In another embodiment of the present invention, a dental appliance is provided which is worn adjacent to teeth in a mouth of a user. The dental appliance has a generally U-shaped upper shell which receives the upper teeth. The dental appliance also has a generally U-shaped lower shell which receives the lower teeth. In addition, the dental appliance has a first spring positioned between the upper shell and the lower shell wherein the spring connects the upper shell to the lower shell and wherein the spring provides a resistive force between the upper shell and the lower shell.

In an embodiment, the dental appliance has a socket within the upper shell wherein the socket is shaped to receive one of the upper teeth of the user.

In an embodiment, the dental appliance has a second spring connected to the first spring.

In an embodiment, the dental appliance has a tab integrally formed with the upper shell wherein the tab extends rearwards into the mouth.

In an embodiment, the dental appliance has the upper shell is constructed from a first material and a second material wherein the first material is softer than the second material.

In another embodiment of the present invention, a method is provided for treating a malocclusion. The method comprises the steps of: creating a first shell based on a shape of upper teeth of a user; creating a second shell based on a shape of lower teeth of the user; and attaching a fastening device to the first shell and the second shell wherein the fastening device has a first member and a second member wherein the first member and second member interlock to removably secure the first shell and the second shell.

In an embodiment, the method further has the step of preventing movement between the first shell and the second shell.

It is, therefore, an advantage of the present invention to provide dental appliances and systems and methods for treating malocclusions which provide essential interconnection between an upper shell and a lower shell to provide antero-posterior and overjet corrections.

Another advantage of the present invention is to provide dental appliances and systems and methods for treating malocclusions which provide essential interconnection between an upper shell and a lower shell to treat overbite.

Still another advantage of the present invention is to provide dental appliances and systems and methods for treating malocclusions in which the dental appliance may treat a malocclusion at a first section of the mouth of the user while maintaining a state of teeth in a second section of the mouth.

Yet another advantage of the present invention is to provide dental appliances and systems and methods for treating malocclusions which reduce the amount of interaction between a dental professional and a patient.

Moreover, an advantage of the present invention is to provide dental appliances and systems and methods for treating malocclusions wherein a single dental appliance may be used to treat a dental condition of a patient.

A further advantage of the present invention is to provide dental appliances and systems and methods for treating malocclusions which lower overall cost of dental care for a patient.

Additional features and advantages of the present invention are described in, and will be apparent from, the detailed description of the presently preferred embodiments and from the drawings.

### BRIEF DESCRIPTION OF THE DRAWINGS

FIG. 1A illustrates a top perspective view of a upper dental appliance in an embodiment of the present invention.

FIG. 1B illustrates a top perspective view of a lower dental appliance in an embodiment of the present invention.

FIG. 2 illustrates a top perspective view of a dental appliance in an embodiment of the present invention.

FIG. 3A illustrates a side view of a dental appliance in an embodiment of the present invention.

FIG. 3B illustrates a side view of a dental appliance in an embodiment of the present invention.

FIG. 4A illustrates a side view of a dental appliance in an embodiment of the present invention.

FIG. 4B illustrates a side view of a dental appliance in an embodiment of the present invention.

FIG. 4C illustrates a side view of a dental appliance in an embodiment of the present invention.

FIG. 5 illustrates a top perspective view of a dental appliance in an embodiment of the present invention.

FIG. 6A illustrates a side view of a dental appliance in an embodiment of the present invention.

FIG. 6B illustrates a top perspective view of a dental appliance in an embodiment of the present invention

FIG. 7A illustrates a top exploded view of a dental appliance in an embodiment of the present invention.

FIG. 7B illustrates a side view of a dental appliance in an embodiment of the present invention.

FIG. 8A illustrates a front view of a dental appliance in an embodiment of the present invention.

FIG. 8B illustrates a side view of a dental appliance in an embodiment of the present invention.

FIG. 9 illustrates a top perspective view of a dental appliance in an embodiment of the present invention.

FIG. 10A illustrates a top perspective view of a dental appliance in an embodiment of the present invention.

FIG. 10B illustrates a top plan view of a dental appliance in an embodiment of the present invention.

FIG. 11A illustrates a side view of a dental appliance in another embodiment of the present invention.

FIG. 11B illustrates a side view of a dental appliance in another embodiment of the present invention.

FIG. 11C illustrates a side view of a dental appliance in another embodiment of the present invention.

FIG. 12A illustrates a front view of a dental appliance in an embodiment of the present invention.

FIG. 12B illustrates a partial side, cross-sectional view of a dental appliance in an embodiment of the present invention.

FIG. 12C illustrates a side view of a dental appliance in an embodiment of the present invention.

FIG. 12D illustrates a side view of a dental appliance in an embodiment of the present invention.

FIG. 13A illustrates a cross-sectional view of an occlusal position of a set of incisors of an individual.

FIG. 13B illustrates a side, cross-sectional view of a dental appliance in an embodiment of the present invention.

### DETAILED DESCRIPTION OF THE PRESENTLY PREFERRED EMBODIMENTS

The present invention relates to dental appliances and systems and methods for treating malocclusions. The dental appliances may have an upper shell which receives the upper teeth of a user. The dental appliance may also have a lower shell which may receive the lower teeth of the user. The upper shell and the lower shell may be computer-generated and attached by various fastening devices. By the attaching the upper shell and the lower shell, the resulting dental appliance may treat malocclusions, such as, for example, overjet or overbite. The upper shell and the lower shell may also be designed to treat malocclusions at a first section of the mouth of the user while maintaining a state of the teeth in a second section of the mouth.

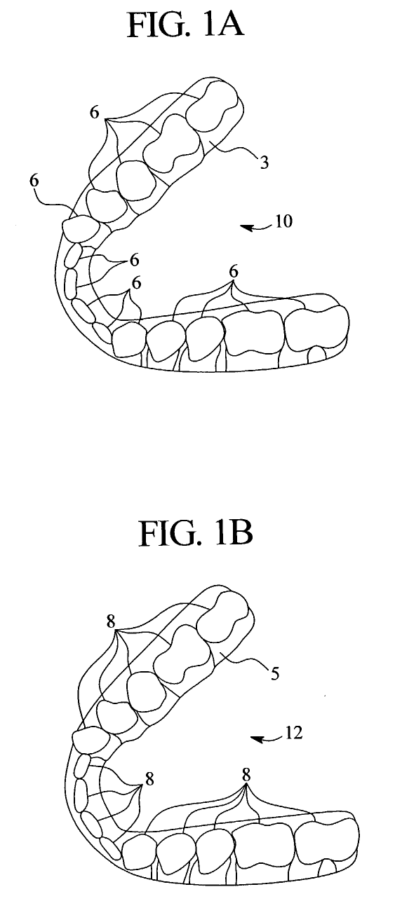

Referring now to the drawings, wherein like numerals refer to like parts, FIG. 1 illustrates an upper shell 10 and a lower shell 12 in an embodiment of the present invention. The upper shell 10 and/or the lower shell 12 may be computer-generated. To this end, laser scanning of models, digital photography, or like technique may be performed on the patient or user. The upper shell 10 and/or the lower shell 12 may then be molded manually, by a vacuum, or by pressure heat machines. In another embodiment, the upper shell 10 and the lower shell 12 may be produced by stereolithography or other related techniques.

The upper shell 10 and the lower shell 12 may then be attached to create a dental appliance. The upper shell 10 and the lower shell 12 may be constructed from, for example, plastic, rubber, polyvinyl chloride, acrylic, silicone, or the like. The upper shell 10 may have a base 3. In addition, the upper shell 10 may have sockets 6 formed within the base 3 for receiving individual upper teeth of a user. Likewise, the lower shell 12 may have a base 5 and may have sockets 8 formed within the base 5 for receiving individual lower teeth of the user.

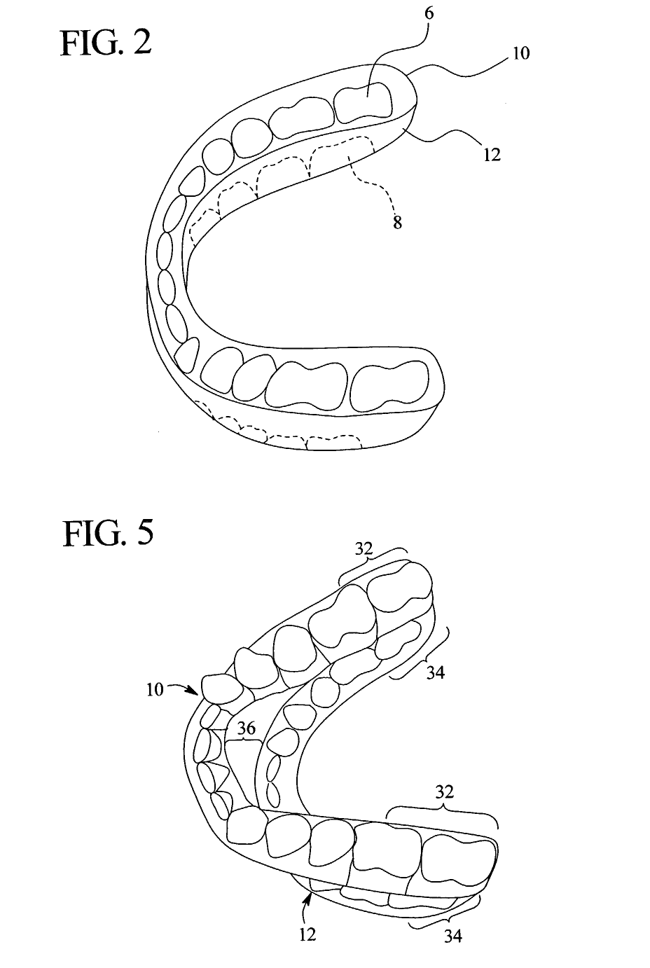

FIG. 2 illustrates the upper shell 10 positioned adjacent to the lower shell 12 wherein the base 3 of the upper shell 10 contacts the base 5 of the lower shell 12. The upper shell 10 may be attached to the lower shell 12 by adhesive or other fastening means, such as, for example, snaps, hook and loop fasteners, or the like.

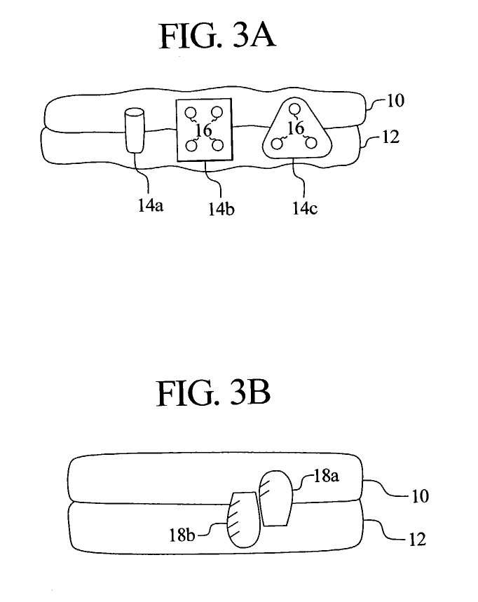

FIGS. 3A and 3B illustrate different fastening methods for fastening the upper shell 10 to the lower shell 12. Specifically, FIG. 3A illustrates the use of snaps 14a, 14b and 14c to attach the upper shell 10 to the lower shell 12. The snap 14a may be constructed from, for example, an elastic material and may be attached to each of the upper shell 10 and the lower shell 12. The snaps 14b and 14c may be constructed from, for example, plastic or other like material. The snaps 14b and 14c may have rods 16 which may be inserted within the upper shell 10 and the lower shell 12 to secure the snaps 14b, 14c to the upper shell 10 and the lower shell 12.

FIG. 3B illustrates wedges 18a, 18b to attach the upper shell 10 to the lower shell 12. The wedges 18a and 18b may be constructed from, for example, of material similar to the dental appliance and molded or formed with the dental appliance as an integral part of the dental appliance or other material, such as wood, metal, or plastic, for example. In addition, the wedges 18a, 18b may be attached to the upper shell 10 or the lower shell 12 by, for example, snaps, hook and loop fasteners and the like. The wedges 18a, 18b may be attached at a left side and a right side of the upper shell 10 and the lower shell 12 with respect to the upper shell 10 and the lower shell 12 being worn in the mouth of a user. Specifically, the wedge 18a may be an upper buccal wedge which may be attached to the upper shell 10 but may not be attached to the lower shell 12. A majority of the wedge 18a may contact the rear portion of the wedge 18b to keep the lower jaw in a forward position. The wedge 18b may be a lower buccal wedge which may be attached to the lower shell 12. A majority of the wedge 18b may contact the wedge 18a. The use of the wedges 18a, 18b may force the user to advance a mandible into a class I antero-posterior jaw position and encourage it to grow into this position.

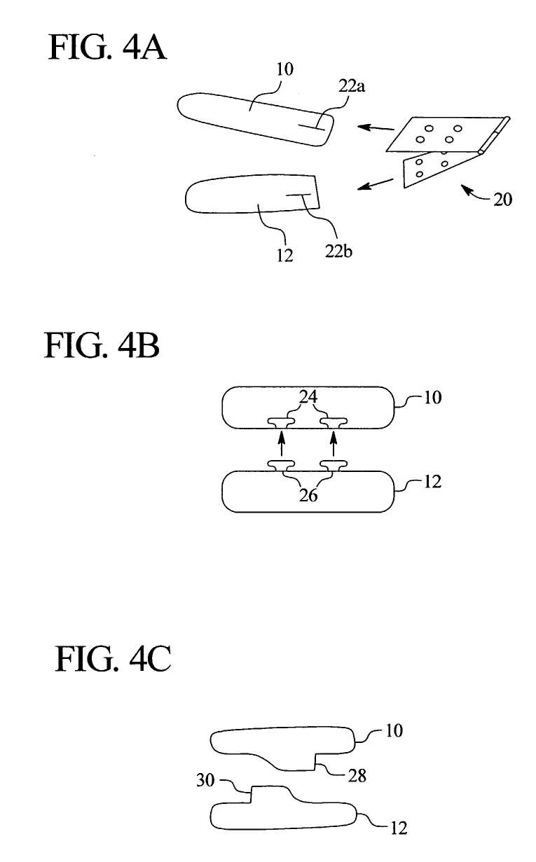

FIGS. 4A through 4C illustrate various methods of adjoining an upper shell 10 and a lower shell 12 of a dental appliance. Referring to FIG. 4A, a hinge 20 may be inserted within a slot 22a in the upper shell and a slot 22b in the lower shell 12. The hinge 20 may be constructed from, for example, metal, plastic, rubber, or the like. The hinge 20 may be inserted into the slots 22a, 22b and may be secured by, for example, interlocking male and female fasteners (not shown), or other like method.

FIG. 4B illustrates the upper shell 10 which may have snaps 24. The lower shell 12 may also have snaps 26. The snaps 24 may be designed to interlock with the snaps 26 to secure the upper shell 10 to the lower shell 12. The snaps 24, 26 may be constructed from, for example, metal, plastic, or the like.

FIG. 4C illustrates an embodiment in which a wedge 28 may be integrally formed in the base 3 of the upper shell 10 along an occlusal surface. A wedge 30 may be integrally formed in the base 5 of the lower shell 12. The wedges 28 and 30 may prevent the upper shell 10 and/or the lower shell 12 from shifting while being worn in the mouth of the user. In another embodiment, the wedge 28 may be attached to the base 3, and/or the wedge 30 may be attached to the base 5. The wedges 28, 30 may be attached by, for example, adhesive, snaps, hook and loop fasteners or the like.

Referring now to FIG. 5, the upper shell 10 may be hingedly connected to the lower shell 12. Specifically, a rear portion 32 of the base 3 may be connected to a rear portion 34 of the base 5. The upper shell 10 and the lower shell 12 may extend from the rear portion 32 and the rear portion 34 at an angle, as generally shown in FIG. 5. A space 36 may be defined between the upper shell 10 and the lower shell 12.

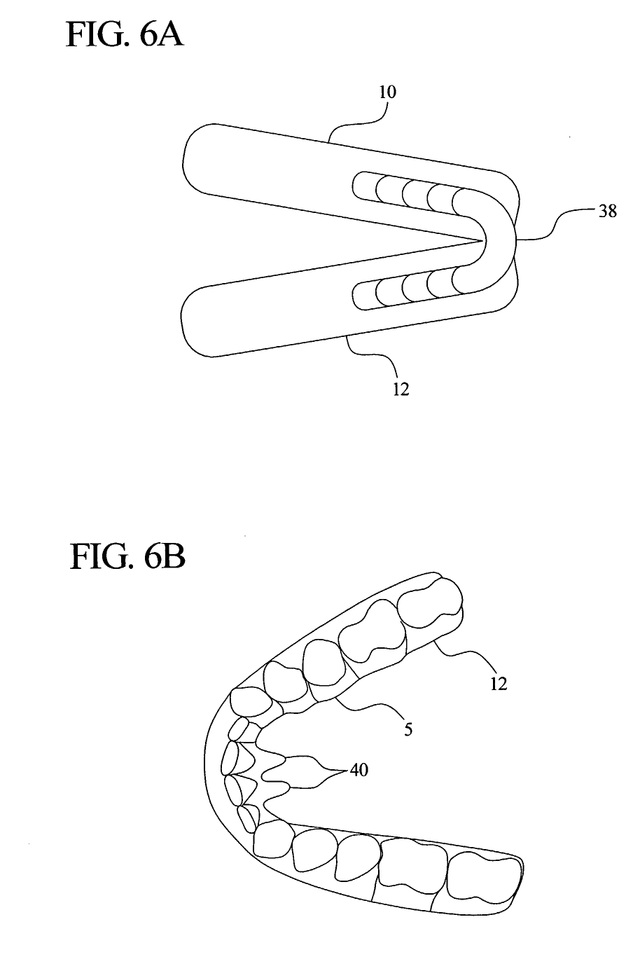

FIG. 6A illustrates a hinge 38 which may be inserted into and fixed within buccal sides and/or lingual sides of the upper shell 10 and the lower shell 12. The hinge 38 may be fixed by friction, glue, or other like method. As illustrated in FIG. 6B, the lower shell 12 may have lingual tabs 40 extending from the base 5. The lingual tabs 40 may be integrally formed with the base 5. In another embodiment, the lingual tabs 40 may be attached to the base 5.

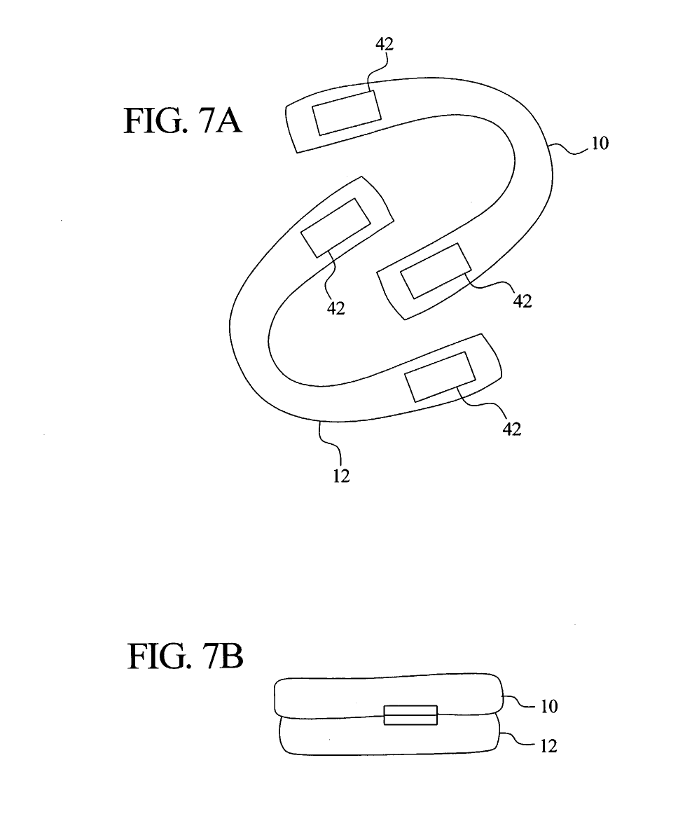

FIGS. 7A and 7B illustrate an embodiment in which magnets 42 may be imbedded within the base 3 of the upper shell 10 and the base 5 of the lower shell 12. The magnets 42 may be sized to fit within the base 3 and the base 5. In an embodiment, the magnets 42 may be attached to the base 3 and/or the base 5. The upper shell 10 and the lower shell 12 may be positioned adjacent to each other wherein the magnets 42 are in proximity to each other, as illustrated in FIG. 7B. An attractive force between the magnets 42 in the base 3 and the magnets 42 in the base 5 may removably secure the upper shell 10 to the lower shell 12. The magnets 42 may be positioned within the upper shell 10 and the lower shell 12 wherein a first magnet may be positioned within the upper shell 10 and a second magnet may be positioned within the lower shell 12. The first magnet and the second magnet may be positioned wherein the first magnet and the second magnet create a repelling force. The repelling force may cause the lower shell 12 to advance in a forward position in relation to the upper shell 10.

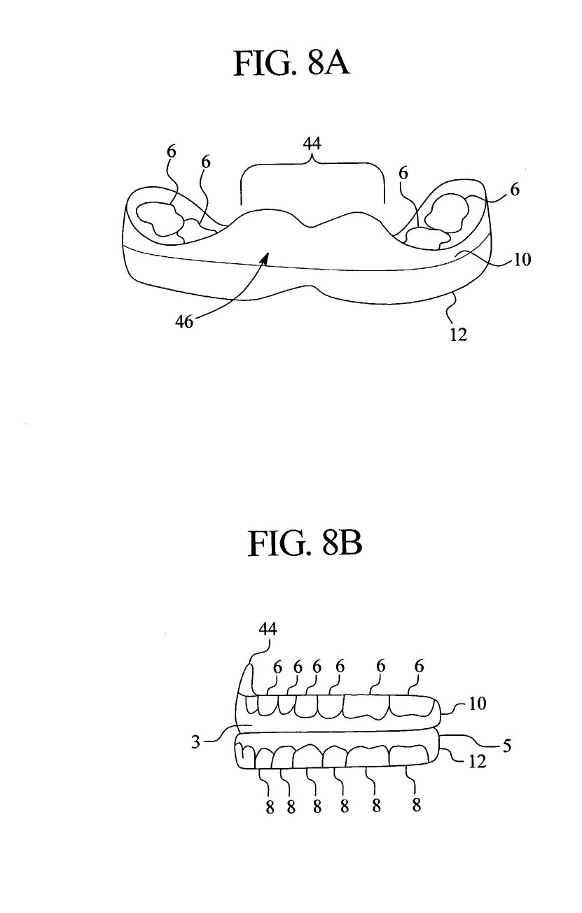

FIGS. 8A and 8B illustrate an embodiment in which the upper shell 10 may have a labial shield 44 extending from a front portion 46. The labial shield 44 may be integrally formed. In an embodiment, the labial shield 44 may be attached to the upper shell 10. The labial shield 44 may prevent the upper shell 10 and the lower shell 12 from slipping rearwards further into the mouth of the user when the mouth is open. The labial shield 44 may also place a distalizing force against the maxilla which may restrict the forward growth of the maxilla.

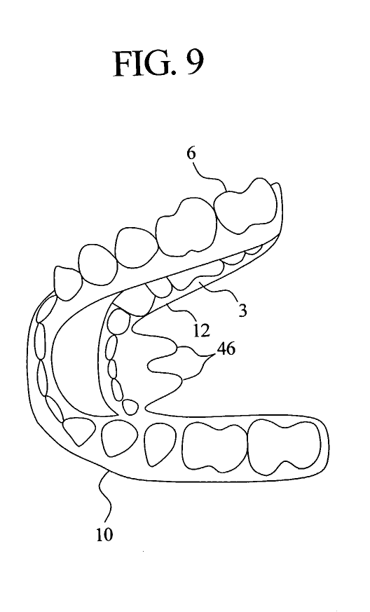

Referring now to FIG. 9, a top perspective view of the upper shell 10 and the lower shell 12 is illustrated. The lower shell 12 may have lingual tabs 46 extending from the base 3. The lingual tabs 46 may be integrally formed with the base 3. In an embodiment, the lingual tabs 46 may be attached to the base 3 by, for example, adhesive, snaps, or other like fastening methods. The lingual tabs 46 may prevent a mandible from slipping rearwards in relation to the upper jaw.

The upper shell 10 and the lower shell 12 may be constructed from one or more materials. The type of materials may be chosen to treat a particular malocclusion. For example, in FIGS. 10A and 10B, the upper shell 10 may be constructed from a hard material at a rear section 48. A front section 50 may be constructed from a softer material in the upper shell 10. The design may be used, for example, to treat users who may have an upper anterior section of the teeth which requires more correction than posterior teeth. Upper posterior teeth may then be set in place while upper anterior teeth are straightened. Known methods of treating this type of malocclusion required a number of dental appliances. However, the dental appliance of the present invention may only require one, or a few, dental appliances to treat the condition. Moreover, the dental appliance of the present invention may enable the user to treat the malocclusion with few, if any, adjustments and/or few, if any, appointments.

In an embodiment, both the upper teeth and the lower anterior teeth may require straightening. As illustrated in FIG. 10B, the lower shell 12 may be constructed from a hard material at a rear section 52 and may be constructed from a softer material at a front section 54. If an excessive overjet is present in the user, the upper shell 10 and the lower shell 12 may be attached by any one or more of the fastening devices disclosed previously or hereinafter.

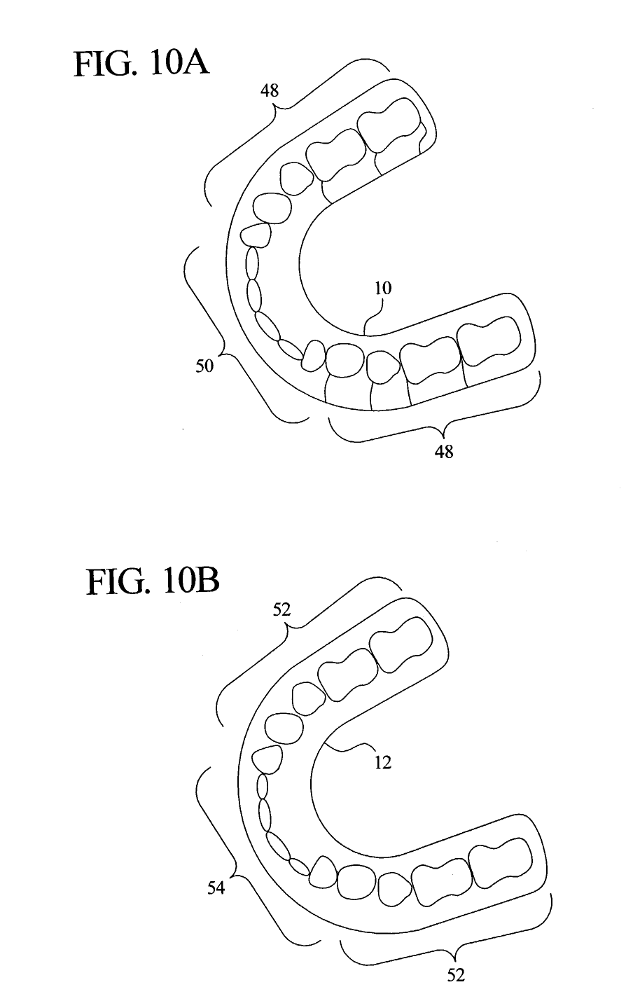

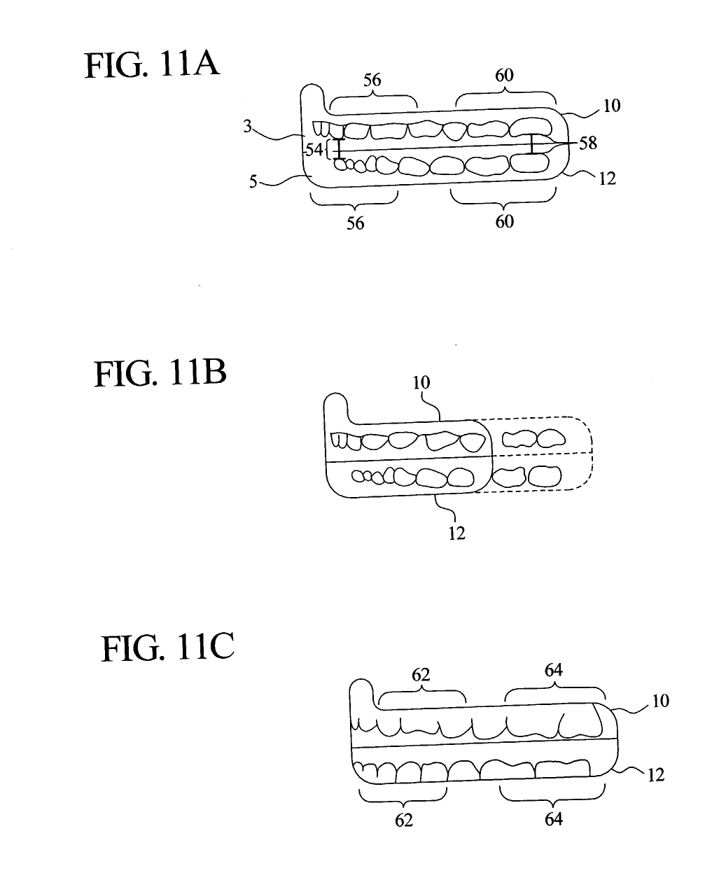

FIGS. 11A and 11B illustrate variations of size and shape of the upper shell 10 and the lower shell 12. Namely, in FIG. 11A, the base 3 of the upper shell 10 and the base 5 of the lower shell 12 may be sized wherein a space 54 extends from the sockets 6 in the upper shell 10 to the sockets 8 in the lower shell 12 at an anterior, or front portion 56. A second space 58 may extend from the sockets 6 to the sockets 8 at a posterior, or rear portion 60. The space 54 may be greater than the space 58. The design may be used to treat excessive overbite. In an embodiment, the space 58 may be greater than the space 54. The resultant dental appliance may then be used to treat anterior openbite. The upper shell 10 and the lower shell 12 may be constructed from a softer material at the front portion 56. As a result, the front teeth may place depressive forces, resulting in no force against back teeth. The back teeth may then erupt.

FIG. 11B illustrates an embodiment in which the upper shell 10 and the lower shell 12 may have a length which does not extend to the first and/or second permanent molars of the user when the upper shell 10 and the lower shell 12 are worn in the mouth of the user. As a result, the molars may supererupt and drive a bite of the patient to an open state to correct the overbite.

FIG. 11C illustrates an embodiment in which the upper shell 10 and/or the lower shell 12 may be constructed from, for example, an elastic material at an anterior portion 62. A posterior portion 64 of the upper shell 10 and the lower shell 12 may be constructed from a hard material. The user, while wearing the upper shell 10 and the lower shell 12, may place a light, vertical, depressive force against the upper incisors and the lower incisors or the anterior teeth. The depressive force may enable the user to correct an overbite condition.

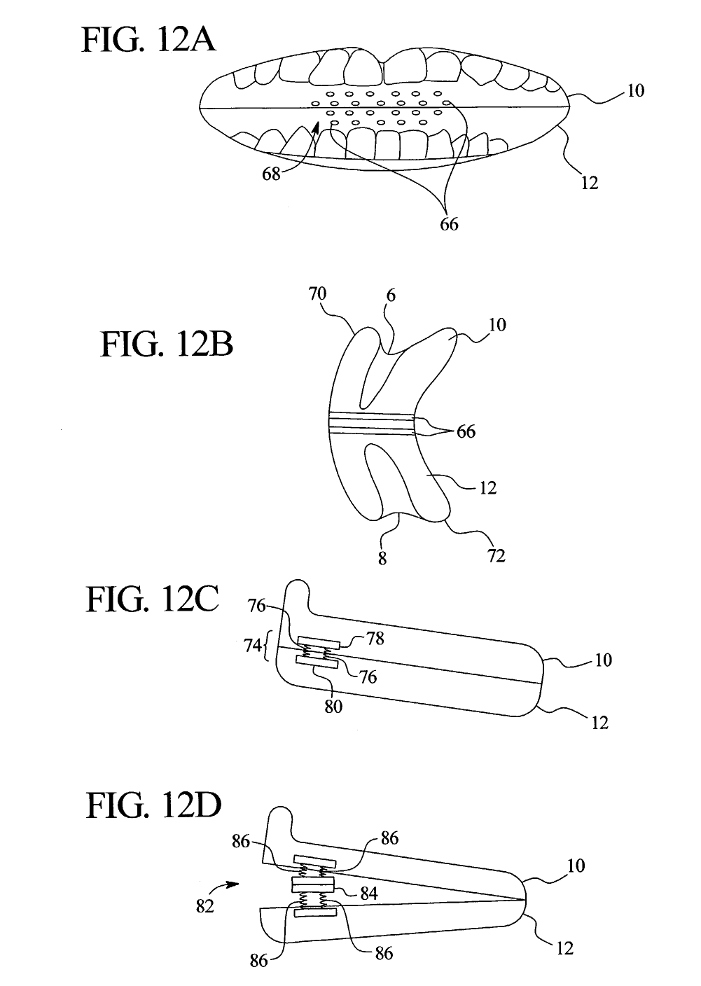

Referring now to FIGS. 12A and 12B, the upper shell 10 and/or the lower shell 12 may have holes 66 at a front section 68. FIG. 12B provides a partial, side, cross-sectional view of the front section 68. The holes 66 may provide an elastic “feel” to the front section 68 which may be useful in treating, for example, overbite. The sockets 6, 8 may be provided for the incisors of the user. A labial shield 70 may be provided on the upper shell 10. In addition, lingual tabs 72 may be provided at the base 5 of the lower shell 12.

FIG. 12C illustrates an embodiment wherein a spring mechanism 74 is positioned between the upper shell 10 and the lower shell 12. The spring mechanism 74 may have a spring 76 which may be attached to a base 78 which may be attached to the upper shell 10. The spring 76 may also be attached to a base 80 which may be attached to the lower shell 12. FIG. 12D illustrates a spring mechanism 82 which may have a base 84 positioned between the base 78 and the base 80. Springs 86 may be provided to connect the base 84 to the base 78 and the base 80. The embodiment illustrated in FIG. 12C may be used to treat overbite by providing a light, vertical force against upper and lower front teeth of the user.

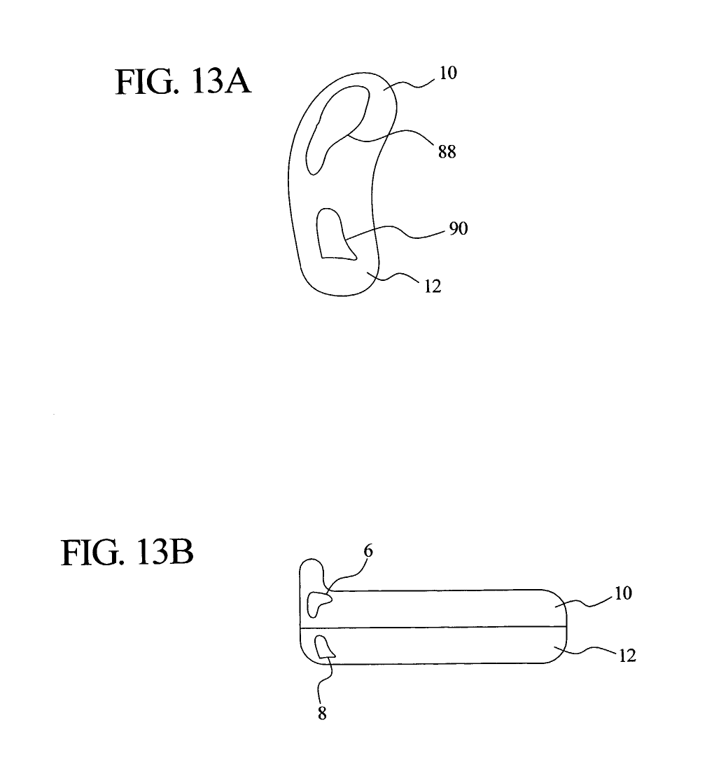

Referring now to FIGS. 13A and 13B, a cross-section of an occlusal position of an upper incisor 88 and a lower incisor 90 of the upper shell 10 and the lower shell 12 are provided for treating a user having overjet and/or overbite. As shown in FIG. 13B, the sockets 6 of the upper shell 10 and the sockets 8 of the lower shell 12 may have a specific alignment. As a result, the upper incisor 88 and the lower incisor 90 may be aligned when the upper shell 10 and the lower shell 12 are worn. The user may then wear the upper shell 10 and the lower shell 12 to correct a malocclusion, such as, for example, overbite or overjet.

Overall, the embodiments of the present invention may be used by a patient to force a mandible to be advanced anteriorly in relation to a maxilla. The embodiments of the present invention may also encourage growth to take place in a more anterior direction. Initial excessive overjet and class II malocclusion may also be corrected by a patient wearing the above embodiments within the mouth while an anterior area is straightened by a softer pre-formed portion of the upper shell 10 and the lower shell 12.

In an embodiment, the upper shell 10 and the lower shell 12 may be attached with more material in the rear section 52 than in the front section 54 to restrict the back teeth of the user from erupting. Moreover, the upper shell 10 and the lower shell 12 may encourage the front teeth to erupt to correct openbite. In an embodiment, the upper shell 10 and the lower shell 12 may be attached wherein the lower jaw of the user may be held in a rearward position in relation to the upper jaw. The upper shell 10 and the lower shell 12 may then be worn to treat a Class III condition.

It should be understood that various changes and modifications to the presently preferred embodiments described herein will be apparent to those skilled in the art. Such changes and modifications may be made without departing from the spirit and scope of the present invention and without diminishing its attendant advantages.

I claim:

1. A dental appliance comprising:
a generally U-shaped upper shell having a first base having a perimeter wherein the first base has a width which is greater than a width of a tooth of a user and further having a wall extending along the perimeter of the upper shell wherein the upper shell has a male portion extending from the first base; and
a generally U-shaped lower shell having a second base having a perimeter wherein the second base has a width which is greater than a width of a tooth of the user and further having a wall extending along the perimeter of the lower shell wherein the lower shell has a female portion sized to receive the male portion wherein the male portion and the female portion interlock to removably secure the lower shell to the upper shell.

2. The dental appliance of claim 1 further comprising:
sockets within the upper shell wherein the sockets are shaped in correlation to individual teeth of the user.

3. The dental appliance of claim 1 further comprising:
a lingual tab extending from the perimeter of the dental appliance.

4. The dental appliance of claim 1 further comprising:
a socket within the first base wherein the socket is sized to receive at least two teeth of the user.

5. The dental appliance of claim 1 further comprising:
holes within the wall.

6. The dental appliance of claim 1 further comprising:
a shield integrally formed along the perimeter of the upper shell.

7. A dental appliance to be worn adjacent to teeth in a mouth of a user, the dental appliance comprising:
a generally U-shaped shell having a base wherein a first area of the shell is constructed from a first material and a second area of the shell is constructed from a second material wherein the first material is softer than the second material.

8. The dental appliance of claim 7 further comprising:
a second shell attached to the generally U-shaped shell wherein the second shell has a generally U-shaped base.

9. The dental appliance of claim 7 further comprising:
sockets within the shell wherein the sockets are shaped to receive the teeth of the user.

10. The dental appliance of claim 7 further comprising:
a lingual tab extending from the base wherein the tab extends toward the mouth of the user.

11. The dental appliance of claim 7 further comprising:
holes within the shell wherein the holes provide flexibility to the shell.

12. The dental appliance of claim 7 wherein the first material is adjacent to teeth requiring correction.

13. The dental appliance of claim 7 wherein the second material is adjacent to teeth to be maintained.

14. A dental appliance worn adjacent to teeth of a user, the dental appliance comprising:
a generally U-shaped first shell wherein the first shell has an outside perimeter and an inside perimeter;
a generally U-shaped second shell wherein the second shell has an outside perimeter and an inside perimeter;
a first wedge on the outside perimeter of the first shell; and
a second wedge on the outside perimeter of the second shell wherein the second wedge contacts the first wedge to prevent movement between the first shell and the second shell.

15. The dental appliance of claim 14 further comprising:
a socket within the first shell wherein the socket is shaped to receive at least one tooth of the user.

16. The dental appliance of claim 14 further comprising:
a tab integrally formed along the inside perimeter of the first shell.

17. The dental appliance of claim 14 further comprising:
a socket shaped to receive at least two teeth of the user.

18. The dental appliance of claim 14 wherein the first shell is constructed from a first material and the second shell is constructed from a second material wherein the first material is softer then the second material.

19. The dental appliance of claim 14 wherein the first wedge is integrally formed with the first shell.

20. The dental appliance of claim 14 wherein the first wedge is attached to the first shell.

21. A dental appliance worn adjacent to teeth in a mouth of a user, the dental appliance comprising:
a generally U-shaped upper shell having a base;
a generally U-shaped lower shell having a base; and
a hinge having a first end and a second end wherein the first end is connected to the upper shell and the second end is connected to the lower shell and wherein the hinge folds at a point between the first end and the second end.

22. The dental appliance of claim 21 further comprising:
a socket within the upper shell having an occlusal surface wherein the socket receives one of the teeth of the user and further wherein the occlusal surface is flat.

23. The dental appliance of claim 21 wherein the upper shell is constructed from a plurality of materials wherein one of the plurality of materials is softer than another material of the plurality of materials.

24. The dental appliance of claim 21 further comprising:
a tab integrally formed with the upper shell wherein the tab has an apex.

25. The dental appliance of claim 21 further comprising:
a shield integrally formed with the upper shell wherein the shield contacts at least one tooth of the user.

26. The dental appliance of claim 21 further comprising:
a socket within the upper shell wherein the socket is shaped to receive at least two of the teeth of the user.

27. A dental appliance worn adjacent to teeth in a mouth of a user, the dental appliance comprising:
a generally U-shaped first base;
a generally U-shaped second base adjacent to the first base; and
a first magnet within the first base.

28. The dental appliance of claim 27 further comprising:
a second magnet within the second base wherein a magnetic force exists between the first magnet and the second magnet.

29. The dental appliance of claim 27 further comprising:
a socket within the first base wherein the socket is shaped to receive at least two of the teeth of the user.

30. The dental appliance of claim 27 further comprising:
holes within the first base.

31. The dental appliance of claim 27 further comprising:
a shield integrally formed with the first base wherein the shield covers the teeth of the user.

32. The dental appliance of claim 27 wherein the first base is constructed from a first material and the second base is constructed from a second material wherein the first material is softer than the second material.

33. The dental appliance of claim 27 further comprising:
a socket within the first base wherein the socket has a shape coinciding with one of the teeth of the user.

34. A dental appliance worn adjacent to teeth in a mouth of a user, the dental appliance comprising:
a generally U-shaped first shell having an outside perimeter and an inside perimeter;
a generally U-shaped second shell having an outside perimeter and an inside perimeter; and
a fastening device attached to the first shell and the second shell wherein the fastening device has a male portion attached to the first shell and a female portion attached to the second shell wherein the male portion and the female portion engage to removably attach the first shell to the second shell.

35. The dental appliance of claim 34 further comprising:
a socket within the first shell wherein the socket is sized to receive at least one tooth of the user.

36. The dental appliance of claim 34 wherein the first shell is constructed from a first material and a second material wherein the first material is softer than the second material.

37. The dental appliance of claim 34 wherein the fastening device is snaps.

38. The dental appliance of claim 34 further comprising:
a shield integrally formed with the first shell wherein the shield contacts at least one tooth of the user.

39. The dental appliance of claim 34 further comprising:
a socket within the first shell wherein the socket has a flat occlusal surface.

40. A dental appliance worn adjacent to teeth in a mouth of a user and having a length defined between a first end and a second end, the dental appliance comprising:
a generally U-shaped first shell having a top surface which receives upper teeth of a user;
a generally U-shaped second shell having a bottom surface which receives lower teeth of the user; and
a fastening device removably attaching the first shell and the second shell wherein a first distance between the top surface and the bottom surface at the first end is greater than a second distance between the top surface and the bottom surface at the second end.

41. The dental appliance of claim 40 further comprising:
a socket within the first shell wherein the socket is sized to receive at least two of the teeth of the user.

42. The dental appliance of claim 40 wherein the fastening device is an adhesive.

43. The dental appliance of claim 40 further comprising:
a tab integrally formed with the first shell wherein the tab extends rearward into the mouth.

44. The dental appliance of claim 40 wherein the upper shell is constructed from a plurality of materials having different degrees of rigidity.

45. The dental appliance of claim 40 further comprising:
a socket within the first shell wherein the socket is sized to receive one of the teeth of the user.

46. A dental appliance worn by a user having anterior teeth and posterior teeth, the dental appliance comprising:
a generally U-shaped upper shell;
a generally U-shaped lower shell adjacent to the upper shell wherein the upper shell and lower shell are sized to contact the anterior teeth of the user and wherein the upper shell and the lower shell do not contact at least one posterior tooth of the user; and
a fastening device removably attaching the upper shell and the lower shell.

47. The dental appliance of claim 46 further comprising:
a female portion formed with the upper shell and a male portion formed with the lower shell.

48. The dental appliance of claim 46 wherein the upper shell is softer in an area which contacts teeth requiring correction.

49. The dental appliance of claim 46 further comprising:
a hinge connected to the upper shell and the lower shell.

50. The dental appliance of claim 46 further comprising:
a shield integrally formed with the upper shell wherein the shield covers the teeth.

51. The dental appliance of claim 46 wherein the fastening device is snaps.

52. The dental appliance of claim 46 further comprising:
a socket within the upper shell wherein the socket has a flat occlusal surface.

53. A dental appliance worn in a mouth of a user having upper teeth and lower teeth, the dental appliance comprising:
a generally U-shaped upper shell which receives the upper teeth;
a generally U-shaped lower shell which receives the lower teeth; and
a first spring positioned between the upper shell and the lower shell wherein the spring connects the upper shell to the lower shell and wherein the spring provides a resistive force between the upper shell and the lower shell.

54. The dental appliance of claim 53 further comprising:
a socket within the upper shell wherein the socket is shaped to receive one of the upper teeth of the user.

55. The dental appliance of claim 53 further comprising:
a second spring connected to the first spring.

56. The dental appliance of claim 53 further comprising:
a tab integrally formed with the upper shell wherein the tab extends rearwards into the mouth.

57. The dental appliance of claim 53 wherein the upper shell is constructed from a first material and a second material wherein the first material is softer than the second material.

58. A method for treating a malocclusion, the method comprising the steps of:
creating a first shell based on a shape of upper teeth of a user;
creating a second shell based on a shape of lower teeth of the user; and
attaching a fastening device to the first shell and the second shell wherein the fastening device has a first member and a second member wherein the first member and second member interlock to removably secure the first shell and the second shell.

59. The method of claim 58 further comprising the step of:
preventing movement between the first shell and the second shell.

60. A dental appliance comprising an upper shell designed to receive the upper teeth of a user and a lower shell designed to receive the lower teeth of the user wherein the dental appliance comprises connecting means for removably attaching the upper shell to the lower shell.

61. A dental appliance according to claim 60 wherein the connecting means comprise interlockable snaps located on both the upper and lower shells.

62. A dental appliance according to claim 60 wherein the connecting means comprise interlockable wedges located on both the upper and lower shells.

63. A dental appliance according to claim 62 wherein the wedges are integrally formed in the dental appliance.

64. A dental appliance according to claim 60 wherein the connecting means comprise an upper buccal wedge attached to the upper shell and a lower buccal wedge attached to the lower shell.

65. A dental appliance according to claim 60 wherein the upper shell comprises an upper hinge slot and the lower shell comprises a lower hinge slot and wherein the connecting means comprise a hinge, one end of which is insertable into the upper hinge slot and the other end of which is insertable into the lower hinge slot.

66. A dental appliance according to claim 65 wherein the hinge is retained in the upper and lower hinge slots by a friction fit.

67. A dental appliance according to claim 60 wherein the connecting means comprise magnets.

68. A dental appliance according to claim 67 wherein the magnets are located within the upper and lower shells, so as to be adjacent in use.

69. A dental appliance according to claim 60 wherein the connecting means comprise loop fasteners.

70. A dental appliance according to claim 60 additionally comprising lingual tabs.

71. A dental appliance according to claim 70 wherein the lingual tabs are attached to the lower shell.

72. A dental appliance according to claim 60 additionally comprising a labial shield.

73. A dental appliance according to claim 72 wherein the labial shield is attached to the upper shell.

74. A dental appliance according to claim 60, constructed from plastic, rubber, silicone or a mixture of these materials.

75. A dental appliance according to claim 73 wherein the dental appliance comprises polyvinyl chloride, acrylic or a mixture of these materials.

76. A dental appliance according to claim 60, which is sized not to extend to the first and/or second permanent molars of the user.

77. A dental appliance according to claim 60, comprising areas of hard material and areas of relatively soft material.

78. A dental appliance according to claim 60, comprising holes in a front portion of the lower and/or upper shell.

79. A method of treating dental malocclusions, particularly overjet or overbite, especially in users with deciduous dentition, comprising the step of fitting the user with a dental appliance comprising an upper shell designed to receive the upper teeth of a user and a lower shell designed to receive the lower teeth of a user, wherein the dental appliance comprises connecting means for removably attaching the upper shell to the lower shell.

80. A method of correcting dental malocclusions, particularly overjet or overbite, especially in users with a deciduous dentition, comprising the steps of:
producing a physical or a digital model of the user's mouth;
producing a dental appliance based on the physical or digital model, the dental appliance comprising an upper shell designed to receive the upper teeth of a user and a lower shell designed to receive the lower teeth of the user wherein the dental appliance comprises connecting means for removably attaching the upper shell to the lower shell; and
fitting the user with the dental appliance and requiring them to wear it in an appropriate fashion until the malocclusion is corrected.

81. A method according to claim 80 wherein the digital model is prepared from a laser scan of the user's mouth.

82. A method according to claim 80, wherein the dental appliance is produced manually, by vacuum molding, by pressure or heat molding, by stereolithography or by a combination of these techniques.
